(19) United States
(12) Patent Application Publication
(10) Pub. No.: US 2020/0288750 A1
(43) Pub. Date: Sep. 17, 2020

(54) Reduction of Pathogens and Other Bacteria in Food and Feed Products Utilizing a Multiple Inhibition System with Lactic Acid Bacteria

(71) Applicant: Texas Tech University System, Lubbock, TX (US)

(72) Inventors: Mindy M. Brashears, Wolfforth, TX (US); Kendra Nightingale, Lubbock, TX (US); David Campos, Muleshoe, TX (US)

(21) Appl. No.: 16/769,280

(22) PCT Filed: Dec. 5, 2018
(86) PCT No.: PCT/US2018/064080

§ 371 Date: Jun. 3, 2020

Related U.S. Application Data
(60) Provisional application No. 62/594,808, filed on Dec. 5, 2017.

(51) Int. Cl. A23K 30/00; A23K 40/30; A23K 10/18; A23K 10/26; A23K 50/42

(52) U.S. Cl. CPC A23K 30/00; A23K 40/30; A23Y 2220/79; A23K 10/26; A23K 50/42; A23K 10/18

(57) ABSTRACT

The present invention includes compositions and methods for inhibiting the growth of pathogens in an animal feed comprising the steps of: contacting the animal feed with at least one lactic acid bacterium strain selected from at least one of Lactobacillus salivarius strains L14, L15, L17, L28, or a mixture thereof; or a whey obtained from fermentation of the lactic acid bacterium strain, wherein the at least one lactic acid bacterium strain inhibits the growth of the pathogens, the nosocomial pathogens or the spoilage microorganisms in the animal feed.

### TECHNICAL FIELD OF THE INVENTION

The present invention relates in general to the field of reducing pathogens and other bacteria in food and feed products using a multiple inhibition system with lactic acid bacteria.

### BACKGROUND OF THE INVENTION

Without limiting the scope of the invention, its background is described in connection with animal feed.

U.S. Pat. No. 8,894,991, issued to Boileau, et al., entitled “Canine probiotic Lactobacilli”, is directed to a strain of lactic acid bacteria of the genus Lactbacilli obtainable by isolation from resected and washed canine gastrointestinal tract having a probiotic activity in animals. Methods of use and compositions comprising the Lactbacilli are also said to be provided. Specifically, the strain has the ability to survive and colonize the gastrointestinal tract of a companion animal, is able to maintain viability following 1 hour at pH 2.5, and is selected from Lactbacillus murinus strain AHC1222, Lactbacillus murinus strain AHC5323, Lactbacillus murinus strain AHC6331, and Lactbacillus murinus strain AHC3133.

U.S. Pat. No. 8,771,675, entitled “Probiotic Strains for Pets” disclose novel strains of probiotics for use in the gastrointestinal tract of a pet. The probiotics are capable of fermenting starch to produce lactic acid and/or hydrogen peroxide anti-pathogenic metabolites.

U.S. Patent Application Publication No. 2013/0011374, entitled “Growth Inhibition of Microorganisms by Lactic Acid Bacteria,” relates to growth inhibition of microorganisms by lactic acid bacteria; the reduction and/or treatment of food-borne pathogen infections and/or nosocomial infections; the inhibition of spoilage microorganisms in food products and the modulation of gut flora.

### SUMMARY OF THE INVENTION

In one embodiment, the present invention includes a method for inhibiting the growth of pathogens in an animal feed comprising the steps of: contacting the animal feed with at least one lactic acid bacterium strain selected from at least one of Lactbacillus salivarius strains L14, L15, L17, L28, or a mixture thereof; or a whey obtained from fermentation of the lactic acid bacterium strain, wherein the at least one lactic acid bacterium strain inhibits the growth of the pathogens, the nosocomial pathogens or the spoilage microorganisms in the animal feed. In one aspect, the at least one lactic acid bacterium strain is admixed in or with the animal feed, or coated on the animal feed. In another aspect, the animal feed is a cat food, dog food, horse food, cow food, chicken food, snake food, or other animal food. In another aspect, the animal feed is a kibble, moist feed, or wet feed. In another aspect, the pathogens are selected from the group consisting of Staphylococcus aureus, Listeria innocua, Listeria monocytogenes, Enterococcus faecium, and Enterococcus faecalis. In another aspect, the pathogens are selected from the group consisting of Escherichia coli and Salmonella Typhimurium. In another aspect, the pathogens is an Escherichia coli that comprises the O157:H7 serotype. In another aspect, the Lactbacillus salivarius strains are L14 and L28. In another aspect, the animal feed is a cowhide or a bone. In another aspect, the pathogens are selected from the group consisting of Aeromonas caviae; Aeromonas hydrophila; Aeromonas sobria; Bacillus cereus; Campylobacter jejuni; Citrobacter ssp.; Clostridium botulinum; Clostridium perfringens; Enterobacter ssp.; Enterococcus ssp.; Escherichia coli enteroinvasive strains; Escherichia coli enteropathogenic strains; Escherichia coli enterotoxigenic strains; Escherichia coli O157:H7; Klebsiella ssp.; Listeria monocytogenes; Plesiomonas shigelloides; Salmonella ssp.; Shigella ssp.: Staphylococcus aureus; Streptococcus ssp.; Vibrio cholerae; or Yersinia enterocolitica.

In another embodiment, the present invention includes a method for increasing the storage time of an animal feed by reducing the spoilage microorganisms comprising the steps of: combining an animal feed having one or more spoilage microorganisms with at least one lactic acid bacterium strain selected from at least one of Lactbacillus salivarius strains L14, L15, L17, L28, or a mixture thereof; or a whey obtained from fermentation of the lactic acid bacterium strain with the one or more spoilage microorganisms to reduce the number of one or more spoilage microorganisms in contact with the animal feed. In one aspect, the one or more spoilage microorganisms are selected from the group consisting of Aeromonas caviae; Aeromonas hydrophila; Aeromonas sobria; Bacillus cereus; Campylobacter jejuni; Citrobacter ssp.; Clostridium botulinum; Clostridium perfringens; Enterobacter ssp.; Enterococcus ssp.; Escherichia coli enteroinvasive strains; Escherichia coli enteropathogenic strains; Escherichia coli enterotoxigenic strains; Escherichia coli O157:H7; Klebsiella ssp.; Listeria monocytogenes; Plesiomonas shigelloides; Salmonella ssp.; Shigella ssp.: Staphylococcus aureus; Streptococcus ssp.; Vibrio cholerae; or Yersinia enterocolitica. In another aspect, the at least one lactic acid bacterium strain is admixed with the animal feed, or coated on the animal feed. In another aspect, the animal feed is a cat food, dog food, horse food, cow food, chicken food, snake food, or other animal food. In another aspect, the animal feed is a kibble, moist feed, or wet feed. In another aspect, the animal feed is a cowhide or a bone.

In another embodiment, the present invention includes a method for reducing a pathogenic load in an animal feed comprising the steps of: mixing an animal feed having one or more pathogens with at least one lactic acid bacterium strain selected from at least one of Lactbacillus salivarius strains L14, L15, L17, L28, or a mixture thereof; or a whey obtained from fermentation of the lactic acid bacterium strain to reduce the pathogenic load. In one aspect, the one or more pathogens are selected from the group consisting of Staphylococcus aureus, Listeria innocua, Listeria monocytogenes, Enterococcus faecium Enterococcus faecalis, Escherichia coli and Salmonella Typhimurium. In another aspect, the or more pathogens are selected from the group consisting of Aeromonas caviae; Aeromonas hydrophila; Aeromonas sobria; Bacillus cereus; Campylobacter jejuni; Citrobacter ssp.; Clostridium botulinum; Clostridium perfringens; Enterobacter ssp.; Enterococcus ssp.; Escherichia coli enteroinvasive strains; Escherichia coli enteropathogenic strains; Escherichia coli enterotoxigenic strains; Escherichia coli O157:H7; Klebsiella ssp.; Listeria monocytogenes; Plesiomonas shigelloides; Salmonella ssp.; Shigella ssp.: Staphylococcus aureus; Streptococcus ssp.; Vibrio cholerae; Yersinia enterocolitica. In another aspect, the animal feed is a cat food, dog food, horse food, cow food, chicken food, snake food, or other animal food. In another aspect, the animal feed is a kibble, moist feed, or wet feed. In another aspect, the animal feed is a cowhide or a bone.

In yet another embodiment, the present invention includes an animal feed product comprising an animal feed and at least one lactic acid bacterium strain selected from at least one of Lactbacillus salivarius strains L14, L15, L17, L28, or a mixture thereof; or a whey obtained from fermentation of the lactic acid bacterium strain.

In yet another embodiment, the present invention includes a method for inhibiting the exposure of humans to one or more animal pathogens from an animal or pet comprising the steps of: identifying an animal in need of treatment to reduce the exposure of humans to the one or more animal pathogens; and providing the animal or pet with an animal feed that has been prepared or coated with at least one lactic acid bacterium strain selected from at least one of Lactbacillus salivarius strains L14, L15, L17, L28, or a mixture thereof; or a whey obtained from fermentation of the lactic acid bacterium strain, wherein the at least one lactic acid bacterium strain inhibits the growth of the pathogens, the nosocomial pathogens or the spoilage microorganisms in the animal feed. In one aspect, the animal feed is a cat food, dog food, horse food, cow food, chicken food, snake food, or other animal food. In another aspect, the animal feed is a kibble, moist feed, or wet feed.

### DESCRIPTION OF THE DRAWINGS

For a more complete understanding of the features and advantages of the present invention, reference is now made to the detailed description of the invention along with the accompanying figures and in which:

FIG. 1 is a graph that shows the inhibition of Salmonella by novel lactic acid bacteria (L14 and L28).

FIG. 2 is a graph that shows the inhibition of Salmonella by Lactbacillus salivarius L28 on pet kibble.

FIG. 3 is a graph that compares the inhibition of Salmonella in pet kibble using different lab strains.

FIG. 4 is a graph that shows the inhibition of Salmonella using lactic acid bacterial L28 in lamb meal.

FIG. 5 is a graph that shows the effect of treating cattle rib bones for dogs.

FIG. 6 are graphs that show the effect of Lactbacillus L28 on palatability of dog food.

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not limit the invention, except as outlined in the claims.

Probiotics originates from the Greek term meaning “for life,” and represent living microorganisms that work to replenish gastrointestinal microflora. This gastrointestinal microflora aids in digestion, and leads to greater health. Animals such as dogs and cats must have a strong and healthy microflora because of the stress they induce on their intestines from their unfiltered eating habits. While probiotic products are available for dogs and cats, there are not in-store distinctions for which probiotics to give the respective species.

As used herein, the term “bacteriocidal effect” refers to any type of treatment which effects the killing of bacteria (i.e. which reduce their numbers). This is in contrast to a “bacteriostatic effect” which refers to the situation where the treatment only inhibits the growth or reproduction of the bacteria. An agent is said to be a bactericide or a bacteriocide if the agent is able to kill one or more type of bacteria. A bacteriocide is said to possess bacteriocidal or bactericidal activity.

As used herein, the term “bacteriocins” refers to peptides or protein molecules released extracellularly that are able to kill certain other closely related bacteria by a mechanism by which the producer cell exhibits a degree of specific immunity.

As used herein, the term “dairy product” is intended to include any food product made using milk or milk products, including, but not limited to, milk, yogurt, ice cream, cheese, butter, and cream.

As used herein, the term “effective amount” refers to the amount of the invention which gives rise to an inhibition of the bacterial growth or a reduction of the number of other bacteria from the food product.

As used herein, the term “animal feed” refers to feed for an animal that provides basic nutrition and an improvement of the health of livestock, poultry, fish, birds, reptiles, and domestic animals. The animal feed may be in the form of powder, grain or liquid form and may be used in accordance with the feeding condition and installations of the farm and the target animal. Animal feedstuffs often include, e.g., green feed, silages, dried green feed, roots, tubers, fleshy fruits, grains and seeds, brewer's grains, pomace, brewer's yeast, distiller's spent grains, milling byproducts, byproducts of the production of sugar, starch and oil recovery and various food wastes. The animal feed may also include feed additives used alone or in conjunction with other well-known feed additives such as antioxidants or mixtures of various substances (mineral mixtures, vitamin mixtures) that can be added to such feeds for enhancement. Specific feeds may also be adapted for certain animal species depending on age and stages of development.

Base animal feeds suitable for use in conjunction with the present invention may be prepared as is well-known to the artisan skilled in the art of preparing feeds, e.g., they may use those as described in Kirk-Othmer, Encyclopedia of Chemical Technology, 4th Ed., vol. 10, pp. 288-300, Wiley, N.Y., 1993, relevant portions incorporated herein by reference. For example, the base feed may include one or more of the following ingredients: corn, sorghum, barley, wheat, soybean, peanut, canola, fish meal, milk products, fats and oils, vitamins and minerals.

As used herein, the terms “food product” and “food stuff” refer to any food that is susceptible to spoilage as a result of bacterial growth and proliferation, e.g., but not limited to, meat, dairy products, vegetables, fruits and grains.

As used herein, the term “livestock” refers to, e.g., cattle, sheep, pigs, goats, horses, donkeys, mules, buffalo, oxen, or camels, namely, farm animals used in agriculture.

As used herein, the term “meat” refers to any meat product or meat by-product (including those processed) from an animal which is consumed by humans or animals, including, without limitation, meat from bovine, ovine, porcine, poultry, fish and crustaceous seafood. As used in the present application, the term “ready to eat meat product”, also referred to as RTE meat product, is intended to include any meat product which does not require cooking prior to consumption.

As used herein, the terms “refrigerated product” or “preserved in a refrigerated state” are equally used and refer to food products which are stored at temperatures ranging from to 2 to 10° C. The food product can be packaged, packaged under vacuum or packaged at modified atmosphere.

As used herein, the term “shelf life” refers to the period of time that a food product remains saleable to retail customers. In traditional meat processing, the shelf life of meat and meat by-products is about 30 to 40 days after an animal has been slaughtered. Refrigeration of meat during this period of time is expected to largely arrest and/or retard the growth of pathogenic bacteria, and to a lesser extent, spoilage bacteria. After about 30 to 40 days, however, refrigeration is no longer able to effectively control the proliferation of spoilage bacteria below acceptable levels.

As used herein, the term “spoilage bacteria” refers to any type of bacteria that act to spoil food. Spoilage bacteria may grow and proliferate to such a degree that a food product is made unsuitable or undesirable for human or animal consumption. Bacteria are able to proliferate on food surfaces, such as meat surfaces, by assimilating sugars and proteins on such surfaces. By metabolizing these components, spoilage bacteria create by-products including carbon dioxide, methane, nitrogenous compounds, butyric acid, propionic acid, lactic acid, formic acid, sulfur compounds, and other undesired gases and acids. The production of such by-products alters the color of meat surfaces, often turning meat from a red color to a brown, grey or green color. Gaseous by-products generated by spoilage bacteria also give spoiled meat an undesirable odor. The color and odor alterations of meat due to the growth of spoilage bacteria on a surface of a meat product often make such food product unsaleable to consumers.

In addition to the control of spoilage bacteria, another significant concern in the food processing industry is controlling the growth of food-borne pathogenic bacteria. As used herein, the term “food-borne pathogenic bacteria” refers to any food poisoning organism that is capable of causing disease or illness in animals or humans. The term “pathogenic bacteria” will be understood to include bacteria that infect the food product (for instance meat) and thereby cause disease or illness, as well as bacteria that produce toxins that cause disease or illness. The pathogenic bacteria may be selected from the group: Aeromonas caviae; Aeromonas hydrophila; Aeromonas sobria; Bacillus cereus; Campylobacter jejuni; Citrobacter ssp.; Clostridium botulinum; Clostridium perfringens; Enterobacter ssp.; Enterococcus ssp.; Escherichia coli enteroinvasive strains; Escherichia coli enteropathogenic strains; Escherichia coli enterotoxigenic strains; Escherichia coli O157:H7; Klebsiella ssp.; Listeria monocytogenes; Plesiomonas shigelloides; Salmonella ssp.; Shigella ssp.: Staphylococcus aureus; Streptococcus ssp.; Vibrio cholerae; Yersinia enterocolitica. More preferably, the pathogenic-bacteria are

Listeria monocytogenes.

### EXAMPLE 1

### Lactic Acid Bacteria for the Control of Salmonella in Chicken Fat Used as Pet Food Ingredient

Pets can be a source of pathogenic bacteria to the household environment. Animals may be asymptomatic carriers of Salmonella and shed it in the feces, which may in turn contaminate humans in close contact. Therefore, from a veterinary and human public health perspective, the control of Salmonella in pet foods is critical. Lactic acid bacteria (LAB) can effectively inhibit growth of Salmonella by competitive exclusion and inhibition.

The objective of this example was to evaluate the effect of novel LAB cultures (L14, L28) on the reduction of Salmonella in raw chicken fat. Furthermore, a LAB intervention may be able to be applied to other pet food ingredients.

Materials and methods. Samples of chicken fat were inoculated with a Salmonella cocktail (S. Enteriditis, S. Newport and S. Typhimurium). Each sample consisted of 40 ml of chicken fat for a final concentration of ca. 10³ CFU/ml. Treatment groups received either L14 (Enterococcus hirae) or L28 (Lactbacillus salivarius) at final concentration of 10⁶CFU/ml. Each chicken fat sample was stored at room temperature (25° C.) and 10-ml portions were taken and quantified for Salmonella on Xylose Lysine deoxycholate (XLD) agar at days 0, 1, and 3.

Results. The study was replicated 3 times and after 1 day there were statistical significant differences (P<0.05) between the control and the treatments for counts of Salmonella. After 1 and 3 days, Salmonella in the control chicken fat had grown to approximately 5.49 log CFU/ml and log 7.13 CFU/ml, respectively. In comparison to day 3 control, the L14 treatment, there was a 4.06 log reduction of Salmonella. Moreover, in comparison to day 3 control, on day 3 for L28 treatment there was a 7.13 log reduction and was not detectable by means of direct agar plating.

Conclusions/applications. It was found that Pets that consume contaminated pet kibble can be colonized with Salmonella without exhibiting clinical signs, making the pet a possible source of contamination to people in the household. Pet kibble coated with either of the two lactic acid bacteria can be used to help reduce the Salmonella counts on pet kibble. LAB can be provided to processors in various forms (frozen, liquid or freeze-dried) and application can be easily implemented into current operations.

### EXAMPLE 2

### Lactic Acid Bacteria L28 (Lactbacillus salivarius) and L14 (Enterococcus hirae) Inhibition of Salmonella (Typhimurium, Enteritdis and Newport) in chicken fat pet food ingredient.

Chicken fat being a rich energy source has many important functions in the canine and feline diet. It is often used as a coating for pet food kibble. Dogs and other pets that consume salmonella contaminated food can shed salmonella and may, therefore, be a source of environmental contamination potentially leading to human illness. Lactic acid bacteria (LAB) can efficiently inhibit growth of this pathogen by producing a wide range of antimicrobial metabolites. The objective of this study was to evaluate the effect of novel isolated lactic acid bacteria (LAB)(L14, L28) on reducing the amount of Salmonella (Typhimurium, Enteritdis and Newport) in raw chicken fat stored at room temperature.

Methods: For both control and treatment groups, approximately 40 ml of chicken fat was inoculated with a 3-strain Salmonella cocktail for a final concentration of log 3.00 CFU/ml. Each treatment group received respective treatments of either L14 or L28 lactic acid bacteria for a final concentration of log 6.00 CFU/ml. The 40 ml chicken fat was aliquot by 10 ml for each time point, and enumerated on day 0, 1 and 3 on Xylose Lysine deoxycholate (XLD) agar.

Pets that consume contaminated pet kibble can be colonized with Salmonella without exhibiting clinical signs, making the pet a possible source of contamination to people in the household LAB can inhibit Salmonella. Pet kibble coated with either of the two lactic acid bacteria can be used to help prevent pet kibble from being contaminated. Therefore, animals will no longer be agents for spreading salmonella bacteria to humans.

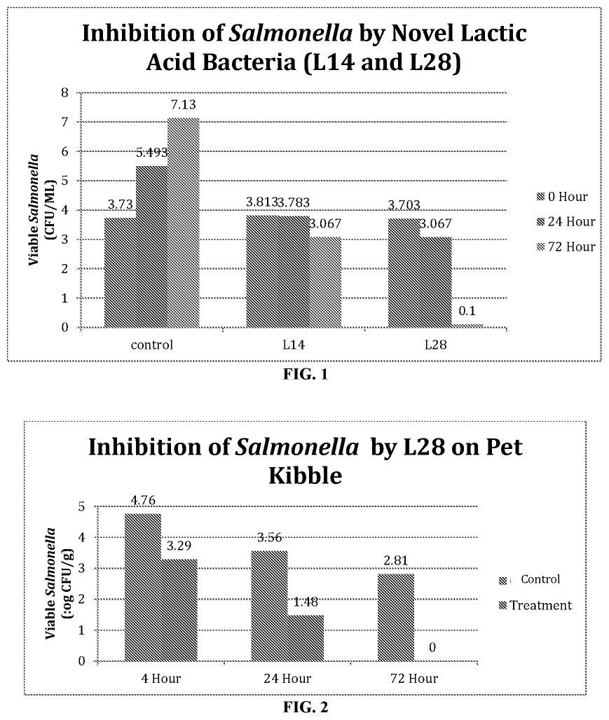

Results: After 1 day there were statistical significant differences (P<0.05) between the control and the treatments for counts of Salmonella. After 1 and 3 days the Salmonella in the control chicken fat had grown to approximately log 5.49 CFU/ml and log 7.13 CFU/ml, respectively. For the L14 treatment on day 3, there was a 4.06 log reduction of Salmonella. On day 3 for L28 treatment there was a 7.13 log reduction and was not detectable by means of direct agar plating. FIG. 1 is a graph that shows the inhibition of Salmonella by novel lactic acid bacteria (L14 and L28), zero hour (left); 24 hour (middle), and 72 hour (right).

### EXAMPLE 3

### Reduction of Salmonella on a Meat-Based Pet Kibble Using Lactbacillus salivarius (L28).

Pets carrying Salmonella in their feces may be a potential vehicle for contamination of the household environment, potentially leading to human illness. Additionally, the pet food itself can be consumed inadvertently by children and pose a direct risk to the consumer.

To determine the effect of Lactbacillus salivarius (L28) on the reduction of Salmonella in dry dog food kibble.

Materials and methods. A cocktail of Salmonella (Enteriditis, Newport, and Typhimurium) was inoculated into a chicken fat coating that was applied to each designated control and treatment sample to yield 10⁶ cfu/g on the product. Each sample was divided into two portions of a control sample and lactic acid bacteria (LAB) treated sample. Treated samples received L28 at concentrations to achieve 10⁸ CFU/g. After treatment, each portion was allowed to dry at room temperature for 4 hours. Pet kibble grab samples of 25 grams were collected and enumerated for Salmonella on XLD agar with a thin-layer overlay at 0, 4, 24, and 72 hours.

At 0 h, the Salmonella counts on the kibble were approximately 6.0 log CFU/g in control and L28 treated samples. After four hours, both the control and treatments decreased in Salmonella, but the treated showed a 1.47 additional log reduction in comparison to the control. At 72 h, the control counts were log 2.8 CFU/g. Furthermore, Salmonella was under the limit of detection after at 72 h of treatment with L28. The experiment was replicated three times and there was a statistical difference between the Salmonella counts on the control and LAB treated pet kibble products. These results demonstrate that L28 may be used to inhibit Salmonella on pet food products, hence reducing the risk of salmonellosis in consumers.

### EXAMPLE 4

### Reduction of Salmonella on Dry Kibble Pet Food Using L28 Lactic Acid Bacteria (Lactbacillus salivarius)

Dogs and other pets that consume Salmonella contaminated food can shed Salmonella and may, therefore, be a source of environmental contamination potentially leading to human illness. The objective is to inhibit Salmonella contamination in dry dog food kibble to prevent further outbreaks.

Methodology: The method used to deliver the Salmonella (Typhimurium, Enteritdis and Newport) and LAB was through a coating of chicken fat applied to the kibble. The chicken fat (40 mL) was inoculated with 1 mL of log 8 CFU/ml of the Salmonella cocktail. The chicken fat was then aliquot into two 20 mL tubes. The control received 20 mL of MRS Broth, and the treatment received 20 mL log 10.0 CFU/mL of L28. Half a pound of dog food was weighed out for the control and treatment, the 60 mL of inoculated chicken fat was added to each. The dog food was allowed to dry for 4 hours. The pet food was evaluated for Salmonella counts on XLD agar at 0 h, 4 h, 24 h, and 72 h.

Results: At 0 h before being dried, the control Salmonella counts were log 6.13 CFU/g while the treatment stood at log 5.94 CFU/g. After the 4 h both the control and treatments fell but the treatment showed a 1.47 log reduction. After 24 hours, both the treatment and control had fallen and were at log 1.48 and log 3.56 CFU/g, respectively. At the 72 h the control counts were log 2.81 CFU/g. Furthermore, the pet kibble treated with lactic acid bacteria was not detectable for Salmonella by direct agar plating method. There was a statistical difference between the control and LAB treated pet kibble products, control (left), treatment (right).

The results show that Lactbacillus salivarius L28 can be used to inhibit Salmonella. Pets that consume contaminated pet kibble can be colonized with Salmonella without exhibiting clinical signs, making the pet a possible source of contamination to people in the household. Pet kibble coated with lactic acid bacteria can be used to help prevent pet kibble from being contaminated. Therefore, animals will no longer be agents for spreading Salmonella bacteria to humans. FIG. 2 is a graph that shows the inhibition of Salmonella by Lactbacillus salivarius L28 on pet kibble.

Application of lactic acid bacteria on pet kibble.(Lactic Acid Bacteria) LAB was grown in MRS broth for 12 hours. It is estimated that the culture will be approximately log 8.00 CFU/ml after this incubation. The cells are super concentrated in a centrifuge at 6000 rpm for 6 minutes. The inventors re-suspend the pelleted cells in 20 ml of the MRS supernatant. It is estimated that the culture will be at log 10.0 CFU/ml. This 20 ml of concentrated is added to 20 ml of chicken fat for a total of 40 ml. This 40 ml is added to ½ pound of uncoated pet kibble. The kibble product will have a final LAB level on the kibble of log 8.00 CFU/g. The kibble is then allowed 4 hours to dry underneath a hood.

### COMPARATIVE EXAMPLE 1

### Evaluation of Various Different Texas Tech University Lactic Acid Bacteria Strain (L14, L15, L17, L19, L28, J35) and Compared to Nutriton Physiology Company Commercial Strain (NP51).

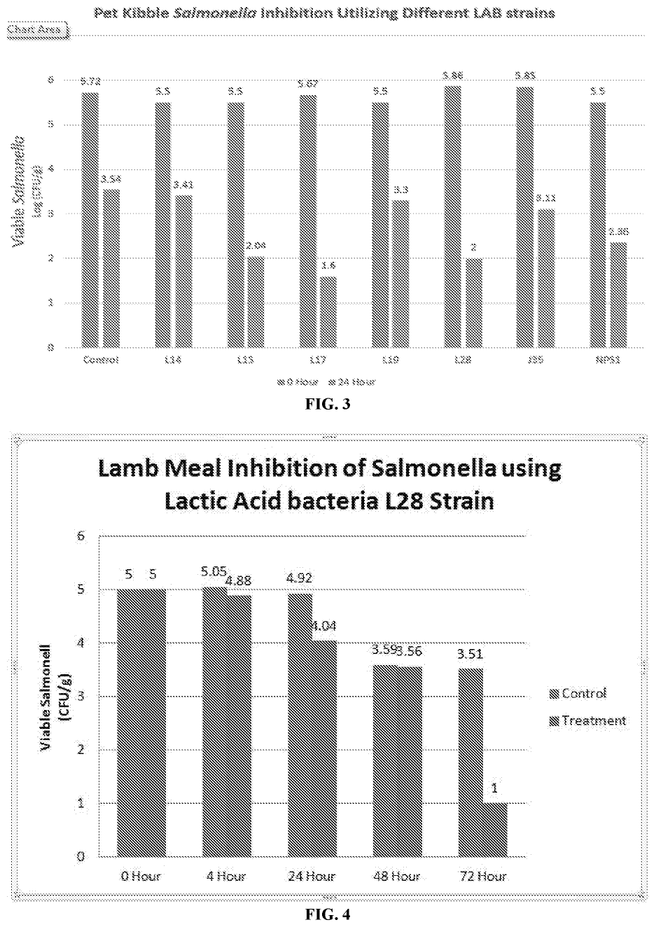

Results: In comparison to the control, L14, L19, J35 had no reduction, and in comparison to the control, L15, L17, L28 and (NP51-commecial strain). L28 was selected for further investigation based on inhibition of other pathogens other than Salmonella. FIG. 3 is a graph that compares the inhibition of Salmonella in pet kibble using different lab strains o hour (left), 24 hour (right).

### EXAMPLE 5

### Inhibition of Salmonella (Typhimurium, Enteritidis, Newport) in Lamb Meal using Lactic Acid Bacteria L28

Next, the inventors sought to reduce the amount of salmonella in lamb meal using a lactic acid bacteria intervention. Lamb meal was prepared by drying the various lactic acid bacteria with a drying temperatures or 25 C. Two samples were evaluated: Control versus Treatment. In the control, 9 ml of MRS blank were add to half pound of lamb meal. In the Treatment 1 sample, 9 ml of MRS that had L28 grown for 24 hours were added to half pound of lamb meal.

Results. Salmonella is drastically reduced after 72 hours of applying the lactic acid bacteria intervention. There is approximately a 2.5 CFU/g reduction in Salmonella. FIG. 4 is a graph that shows the inhibition of Salmonella using lactic acid bacterial L28 in lamb meal, control (left), treatment (right).

Currently the industry uses a Salcurb intervention which is a formaldehyde based chemical. By contrast, the present invention includes a lactic acid bacteria intervention that is environmentally friendly, that does not include harsh chemical treatments, and is safe for animals and their owners.

### EXAMPLE 6

### Reduction of Salmonella on a Pet Treat Bone Derived from Cattle

Next, the inventors evaluated the reduction of Salmonella on a pet treat bone derived from cattle. In this example, the inventors soaked and dried the bones with a lactic acid bacteria intervention.

Methods. Dip the bones in a enriched Salmonella of approximately log 8.00 CFU/ml. Allow a 5 minute attachment for a final salmonella concentration on the pet bone of approximately log 5 CFU/g. The control group was dipped in a MRS broth blank for 10 minutes. The treated group was dipped for 10 minutes in a L28 (Lactbacillus salivarius) enriched for 24 hours at a concentration of approximately log 8.00 CFU/ml.

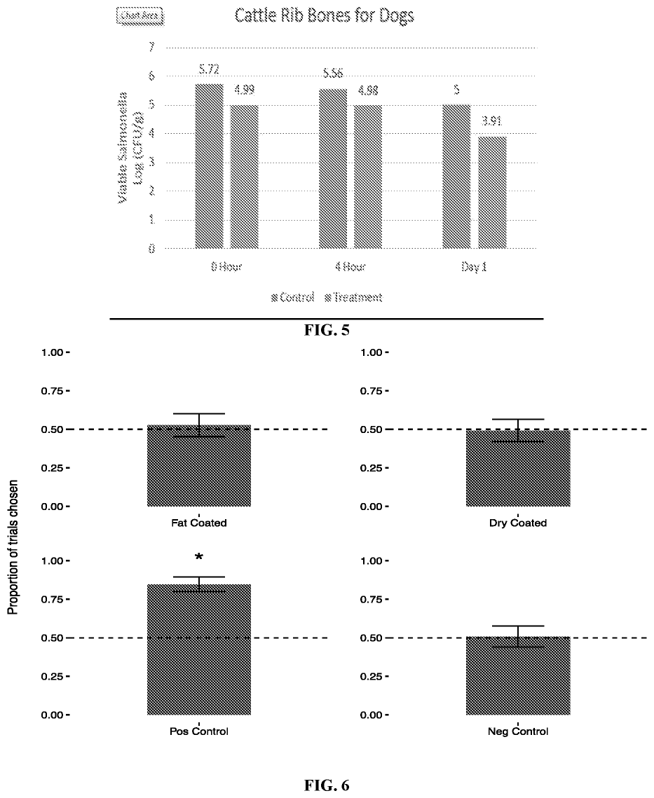

Results. After 1 days there is more than a 1 log reduction (90% reduction of salmonella). Furthermore, if experiment is carried out for further days there may be more reduction of salmonella. FIG. 5 is a graph that shows the effect of treating cattle rib bones for dogs, control (left) and treatment (right).

Currently, industry uses a chemical or a heat treatment intervention to reduce Salmonella. However, some Salmonella may survive these interventions. A lactic acid bacteria intervention could be the last line of defense at reducing salmonella. Moreover, such a probiotic would have health benefits to the host.

### EXAMPLE 7

### Effect of Lactbacillus salivarius on the Palatability of Dog Food

Background. Lactbacillus salivarius (L. salivarius) is a commonly isolated microbe from the mammalian digestive tract. It has been noted as having several potential probiotic characteristics such as the reduction of inflammatory conditions, inhibition of pathogenic bacteria, and could have beneficial effects on increasing the safety of pet foods. It is critical, however, to evaluate whether the addition of a probiotic (L. salivarius) has a negative impact on the acceptability and preference of the dog food, which might limit the probiotic's use in pet foods.

This example evaluates whether L. salivarius affects the palatability of a dog food, and whether the method of adding the probiotic to the food (incorporated in fat or dry coated) influences palatability.

TABLE 1

| Comparison Test | Food 1 | Food 2 |
|---|---|---|
| Fat coat | L. salivarius incorporated | Fat only on uncoated |
| | with fat on uncoated food | food |
| Dry Coat | L. salivarius dry coated | Commercial food |
| | on commercial food | |
| Positive control | Commercial food | Identical uncoated food |
| Negative control | Food identical to food 2 | Food identical to food 1 |

Methods. Thirty dogs were given a two-bowl preference test for four comparisons (see Table). The comparisons evaluated whether the addition of the probiotic (˜log 8 CFU/g) affected palatability. The probiotic was added as part of a fat coating or dry coated. Internal positive and negative controls were added to insure the panel was sensitive to differences in palatability (positive control) and the procedure did not produce spurious preferences when the foods were identical (negative control).

FIG. 6 are graphs that show the effect of Lactbacillus L28 on palatability of dog food. Results. The addition of the probiotic had no significant effect on dogs' food preference. Dogs showed a highly significant preference for the fat coated food during the positive control test verifying the panel was sensitive to palatability differences. The negative control revealed no significant difference, indicating the procedure did not lead to spurious preferences.

Conclusions. The addition of L. salivarius had no significant impact on the palatability of the food regardless of the method the probiotic was added to the food. Subsequent studies can be used to evaluate the effects of adding L. salivarius to dog food in a longer-term feed study, identifying effects on the canine microbiome and the production of pro-inflammatory cytokines.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A method for inhibiting the growth of pathogens in an animal feed comprising the steps of:
contacting the animal feed with at least one lactic acid bacterium strain selected from at least one of Lactbacillus salivarius strains L14, L15, L17, L28, or a mixture thereof; or a whey obtained from fermentation of the lactic acid bacterium strain, wherein the at least one lactic acid bacterium strain inhibits the growth of the pathogens, the nosocomial pathogens or the spoilage microorganisms in the animal feed.

2. The method of claim 1, wherein the at least one lactic acid bacterium strain is admixed in or with the animal feed, or coated on the animal feed.

3. The method of claim 1, wherein the animal feed is a cat food, dog food, horse food, cow food, chicken food, snake food, or other animal food.

4. The method of claim 1, wherein the animal feed is a kibble, moist feed, or wet feed.

5. The method of claim 1, wherein the pathogens are selected from the group consisting of Staphylococcus aureus, Listeria innocua, Listeria monocytogenes, Enterococcus faecium, and Enterococcus faecalis.

6. The method of claim 1, wherein the pathogens are selected from the group consisting of Escherichia coli and Salmonella Typhimurium.

7. The method of claim 1, wherein the pathogens is an Escherichia coli that comprises the O157:H7 serotype.

8. The method of claim 1, wherein the Lactbacillus salivarius strains are L14 and L28.

9. The method of claim 1, wherein the animal feed is a cowhide or a bone.

10. The method of claim 1, wherein the pathogens are selected from the group consisting of Aeromonas caviae; Aeromonas hydrophila; Aeromonas sobria; Bacillus cereus; Campylobacter jejuni; Citrobacter ssp.; Clostridium botulinum; Clostridium perfringens; Enterobacter ssp.; Enterococcus ssp.; Escherichia coli enteroinvasive strains; Escherichia coli enteropathogenic strains; Escherichia coli enterotoxigenic strains; Escherichia coli O157:H7; Klebsiella ssp.; Listeria monocytogenes; Plesiomonas shigelloides; Salmonella ssp.; Shigella ssp.: Staphylococcus aureus; Streptococcus ssp.; Vibrio cholerae; or Yersinia enterocolitica.

11. A method for increasing the storage time of an animal feed by reducing the spoilage microorganisms comprising the steps of:
combining an animal feed having one or more spoilage microorganisms with at least one lactic acid bacterium strain selected from at least one of Lactbacillus salivarius strains L14, L15, L17, L28, or a mixture thereof; or a whey obtained from fermentation of the lactic acid bacterium strain with the one or more spoilage microorganisms to reduce the number of one or more spoilage microorganisms in contact with the animal feed.

12. The method of claim 11, wherein the one or more spoilage microorganisms are selected from the group consisting of Aeromonas caviae; Aeromonas hydrophila; Aeromonas sobria; Bacillus cereus; Campylobacter jejuni; Citrobacter ssp.; Clostridium botulinum; Clostridium perfringens; Enterobacter ssp.; Enterococcus ssp.; Escherichia coli enteroinvasive strains; Escherichia coli enteropathogenic strains; Escherichia coli enterotoxigenic strains; Escherichia coli O157:H7; Klebsiella ssp.; Listeria monocytogenes; Plesiomonas shigelloides; Salmonella ssp.; Shigella ssp.: Staphylococcus aureus; Streptococcus ssp.; Vibrio cholerae; or Yersinia enterocolitica.

13. The method of claim 11, wherein the at least one lactic acid bacterium strain is admixed with the animal feed, or coated on the animal feed.

14. The method of claim 11, wherein the animal feed is a cat food, dog food, horse food, cow food, chicken food, snake food, or other animal food.

15. The method of claim 11, wherein the animal feed is a kibble, moist feed, or wet feed.

16. The method of claim 11, wherein the animal feed is a cowhide or a bone.

17. A method for reducing a pathogenic load in an animal feed comprising the steps of:
mixing an animal feed having one or more pathogens with at least one lactic acid bacterium strain selected from at least one of Lactbacillus salivarius strains L14, L15, L17, L28, or a mixture thereof; or a whey obtained from fermentation of the lactic acid bacterium strain to reduce the pathogenic load.

18. The method of claim 17, wherein the one or more pathogens are selected from the group consisting of Staphylococcus aureus, Listeria innocua, Listeria monocytogenes, Enterococcus faecium Enterococcus faecalis, Escherichia coli and SalmonellaTyphimurium.

19. The method of claim 17, wherein the one or more pathogens are selected from the group consisting of Aeromonas caviae; Aeromonas hydrophila; Aeromonas sobria; Bacillus cereus; Campylobacter jejuni; Citrobacter ssp.; Clostridium botulinum; Clostridium perfringens; Enterobacter ssp.; Enterococcus ssp.; Escherichia coli enteroinvasive strains; Escherichia coli enteropathogenic strains; Escherichia coli enterotoxigenic strains; Escherichia coli O157:H7; Klebsiella ssp.; Listeria monocytogenes; Plesiomonas shigelloides; Salmonella ssp.; Shigella ssp.: Staphylococcus aureus; Streptococcus ssp.; Vibrio cholerae; Yersinia enterocolitica.

20. The method of claim 17, wherein the animal feed is a cat food, dog food, horse food, cow food, chicken food, snake food, or other animal food.

21. The method of claim 17, wherein the animal feed is a kibble, moist feed, or wet feed.

22. The method of claim 17, wherein the animal feed is a cowhide or a bone.

23. An animal feed product comprising an animal feed and at least one lactic acid bacterium strain selected from at least one of Lactbacillus salivarius strains L14, L15, L17, L28, or a mixture thereof; or a whey obtained from fermentation of the lactic acid bacterium strain.

24. A method for inhibiting the exposure of humans to one or more animal pathogens from an animal or pet comprising the steps of:
identifying an animal in need of treatment to reduce the exposure of humans to the one or more animal pathogens; and
providing the animal or pet with an animal feed that has been prepared or coated with at least one lactic acid bacterium strain selected from at least one of Lactbacillus salivarius strains L14, L15, L17, L28, or a mixture thereof; or a whey obtained from fermentation of the lactic acid bacterium strain, wherein the at least one lactic acid bacterium strain inhibits the growth of the pathogens, the nosocomial pathogens or the spoilage microorganisms in the animal feed.

25. The method of claim 24, wherein the animal feed is a cat food, dog food, horse food, cow food, chicken food, snake food, or other animal food.

26. The method of claim 24, wherein the animal feed is a kibble, moist feed, or wet feed.
